(19) United States
(12) Patent Application Publication
(10) Pub. No.: US 2005/0114463 A1
(43) Pub. Date: May 26, 2005

(54) Multi-microprocessor apparatus and slave reset method for the same

(75) Inventor: Seung Yong Lee, Kyunggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Yongin-shi (KR)

(21) Appl. No.: 10/747,443

(22) Filed: Dec. 30, 2003

(30) Foreign Application Priority Data
Nov. 20, 2003 (KR) 2003-82671

(51) Int. Cl. G06F 15/16

(52) U.S. Cl. 709/208

(57) ABSTRACT

A multi-microprocessor apparatus and a slave reset method. Slave microprocessor transmits a response signal when it transmits/receives data to/from the master microprocessor. Master microprocessor resets the slave microprocessor when a time interval between response signals transferred from the slave microprocessor is longer than a predetermined time, such that it can recognize an error or shutdown of the slave microprocessor on the basis of the ACK interrupt signal generated during a signal transmission/reception time based on the I2C protocol communication standard. The master microprocessor automatically resets a corresponding slave microprocessor when it detects the shutdown of the slave microprocessor, resulting in improved system stability and greater convenience for the user.

### RELATED APPLICATION

The present disclosure relates to subject matter contained in Korean Application No. 10-2003-82671, filed on Nov. 20, 2003, which is herein expressly incorporated by reference in its entirety.

### BACKGROUND OF THE INVENTION

1. Field of the Invention

The present invention relates to a multi-microprocessor apparatus and a method for resetting the same, and more particularly to a multi-microprocessor apparatus composed of master and slave microprocessors for recognizing an abrupt halt of the slave microprocessor using a software program, and automatically resetting the slave microprocessor, and a method for resetting the multi-microprocessor apparatus.

2. Description of the Related Art

Typically, as shown in FIG. 1, a multi-microprocessor apparatus has been controlled using two microprocessors, i.e., a master microprocessor M and a slave microprocessor S1. In this case, a plurality of slave microprocessors S2, S3, S4, and S5 capable of controlling different parts of the multi-microprocessor apparatus may also exist in the multi-microprocessor apparatus.

In more detail, a multi-microprocessor apparatus for use in a vehicle may be composed of a master microprocessor for controlling overall operations of the vehicle, and a plurality of slave microprocessors for controlling audio functions and the opening/closing operations of a door or an operation of a warning lamp according to control signals of the master microprocessor.

In this case, the master microprocessor communicates with the slave microprocessor to establish data transmission/reception therebetween, and the slave computer is controlled and administered by a control signal transmitted via the master microprocessor. The master microprocessor must check the condition of the slave microprocessor at all times, and must contain the checked result information of the slave microprocessor.

The above-identified multi-microprocessor apparatus is composed of the mater microprocessor M and a plurality of slave microprocessors S1, S2, S3, S4 and S5. Therefore, provided that one of the slave microprocessors S1, S2, S3, S4 and S5 encounters an unexpected error or is shut down, irrespective of the master microprocessor M, the above-identified multi-microprocessor apparatus has a disadvantage in that all of its microprocessors must be unavoidably reset.

In other words, the whole multi-microprocessor apparatus must be reset to normally operate any one of erroneous slave microprocessors even though the number of the erroneous slave microprocessors is one, such that a user must unavoidably reset the multi-microprocessor apparatus in order to use the multi-microprocessor apparatus.

In addition, provided that the user repeatedly reset the whole multi-microprocessor apparatus when the slave microprocessor is shut down due to the aforementioned problems, even a normal master microprocessor or other normal slave microprocessors are suddenly reset while in operation, resulting in deterioration of system stability and an increased number of system faults.

In the meantime, the user must directly check whether any one of the slave microprocessors is shut down. If the user checks the shutdown of any one of the slave microprocessors, he or she must directly manipulate a prescribed reset key button or must enter a prescribed command to reset the multi-microprocessor apparatus, resulting in greater inconvenience for the user.

### SUMMARY OF THE INVENTION

Therefore, the present invention has been made in view of the above problems, and it is an object of the present invention to provide a multi-microprocessor apparatus for controlling a master microprocessor to automatically recognize an error or shutdown of a slave microprocessor, controlling the master microprocessor to reset only an erroneous slave microprocessor according to the recognized result, resulting in an easier control operation and greater convenience for a user.

In accordance with one aspect of the present invention, the above and other objects can be accomplished by the provision of a multi-microprocessor apparatus controlled by a master microprocessor and a slave microprocessor, comprising: a slave microprocessor for transmitting a response signal to a master microprocessor during a data transmission/reception time therebetween; and a maser microprocessor for resetting the slave microprocessor if a time interval between response signals transferred from the slave microprocessor is longer than a predetermined time.

In accordance with another aspect of the present invention, there is provided a method for resetting a slave microprocessor in a multi-microprocessor apparatus controlled by a master microprocessor and the slave microprocessor, comprising the steps of: a) controlling the master microprocessor to transmit/receive data to/from the slave microprocessor; b) controlling the master microprocessor to count a transmission time interval between response signals transferred from the slave microprocessor while the master microprocessor performs the data transmission/reception at the step (a); and c) controlling the master microprocessor to reset the slave microprocessor when the counted time interval of the step (b) is longer than a predetermined time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a conventional multi-microprocessor apparatus;

FIG. 2 is a block diagram of some parts contained in a multi-microprocessor apparatus in accordance with a preferred embodiment of the present invention;

FIG. 3 is a detailed block diagram of the master and slave microprocessors shown in FIG. 2 in accordance with a preferred embodiment of the present invention; and

FIG. 4 is a flow chart illustrating a method for resetting the slave microprocessor contained in the multi-microprocessor apparatus in accordance with a preferred embodiment of the present invention.

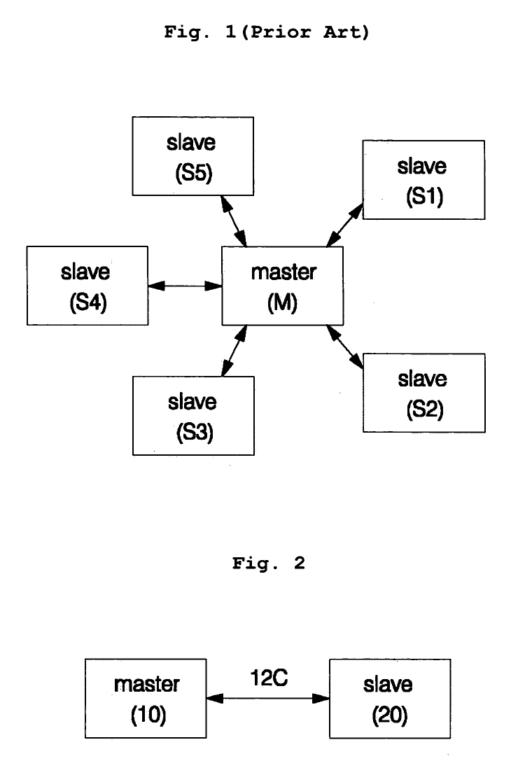

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

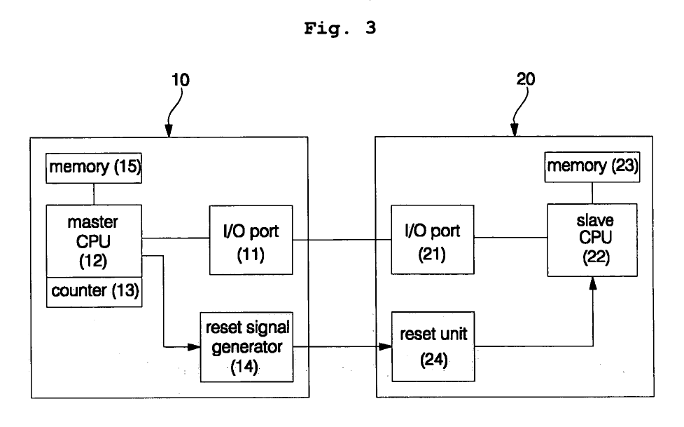

As shown in FIG. 2, a multi-microprocessor apparatus according to the present invention includes a master microprocessor 10 operated by a main microprocessor to control and administer at least one slave contained in the multi-microprocessor apparatus, and a slave microprocessor 20 controlled by a control signal of the master microprocessor 10 to communicate with the master microprocessor 10 according to the I2C protocol standard.

I2C called an Inter-IC indicates a bidirectional serial bus composed of two strips to provide a communication link between ICs (Integrated Circuits). The I2C bus divides a data transfer mode into three data transfer modes (e.g., a standard-speed mode, a high-speed mode, and a superhigh-speed mode) according to a variety of speeds (e.g., a standard speed, a high speed, and a superhigh speed). The standard mode supports a speed of 100 Kbps, the high-speed mode supports a speed of 400 Kbps, and the superhigh-speed mode supports a maximal speed of 3.5 Mbps. All the three modes include downward compatibility therebetween. The I2C bus supports equipments each having address areas of 7 bits and 10 bits, and also supports other equipments operating in different voltages.

The master and slave microprocessors 10 and 20 can establish data transmission/reception using the aforementioned I2C bus (i.e., I2C protocol standard), and can be interoperable with each other.

FIG. 3 is a detailed block diagram of the master and slave microprocessors 10 and 20 shown in FIG. 2 in accordance with a preferred embodiment of the present invention.

The master microprocessor 10 includes an I/O (Input/Output) port 11 for performing data transmission/reception according to an I2C communication standard, and a master CPU (Central Processing Unit) 12 for controlling data transmission/reception operations via the I/O port 11, and controlling overall operations of the multi-microprocessor apparatus.

In the case where the master and slave microprocessors 10 and 20 establish data transmission/reception therebetween, the slave microprocessor 20 continuously transmits or receives a response signal to or from the master microprocessor 10 according to the I2C protocol communication standard.

In more detail, the slave microprocessor generates an ACK (ACKnowledgement) interrupt signal and transmits the ACK interrupt signal to the master microprocessor 10 if 1 byte of data is transmitted or received. Therefore, provided that 1 byte of data is transmitted or received prior to a transmission time of all the transmission/reception bytes, and the next ACK interrupt signal does not occur before sending the next byte of the above 1 byte of data having been transmitted or received, the master microprocessor 10 determines that the slave microprocessor 20 is shut down or generates an unexpected error.

In this case, the master microprocessor 10 further includes a counter 13 connected to the CPU 12 to count a response time interval of the ACK interrupt signal.

A transfer rate of a signal based on the I2C protocol is typically set to 100 Kbps or 400 Kbps. Therefore, the counter 13 determines whether a time interval ranging from an ACK interrupt signal transmission time to the next ACK interrupt signal transmission time is set to a prescribed time of less than 10 ms.

If the time interval is not set to the prescribed time of less than 10 ms, it is determined that the slave microprocessor 20 has not transmitted a response signal or has encountered an unexpected error, such that the master CPU 12 resets the slave microprocessor 20.

The master microprocessor 10 further includes a reset signal generator 14. If the counted time of the counter 13 is longer than a prescribed time of 10 ms, the master microprocessor 10 operates the reset signal generator 14 such that the reset signal generator 14 transmits a reset signal to the slave microprocessor 20.

Furthermore, the master microprocessor 10 further includes a memory 15. The memory 15 connected to the CPU 12 communicates with at least one slave microprocessor, and stores data needed to control and manage the slave microprocessors.

The slave microprocessor 20 includes an I/O port 21 for transmitting/receiving data to/from the master microprocessor 10 according to the I2C communication standard, and a slave CPU 22 for controlling the I/O port 21 and at the same time controlling some parts contained in the multi-microprocessor apparatus according to a control signal of the master microprocessor 10.

The slave CPU 22 receives data via the I/O port 21 according to the I2C communication standard transferred via the I/O port 11 of the master microprocessor 10, and controls operations of the slave microprocessor 20 according to the received data. In this case, the slave CPU 22 is connected to the memory 23 for storing various data needed to perform data transmission/reception and a control operation of the slave microprocessor 20.

Whenever the master and slave microprocessors 10 and 20 perform data transmission/reception operations and transmit/receive 1 byte of data according to the I2C communication standard, the slave CPU 22 generates an ACK interrupt signal, and thereby transmits the generated interrupt signal to the master microprocessor 10.

If the slave microprocessor 10 generates an unexpected error or is shut down and therefore the ACK interrupt signal is not normally transmitted to the master microprocessor 10, the master microprocessor 10 controls the reset signal generator 14 to transmit a reset signal to a reset unit 24 contained in the slave microprocessor 20.

The reset unit 24 compulsorily resets the slave CPU 22 upon receiving the reset signal from the master microprocessor 10, such that the slave microprocessor 20 is reset.

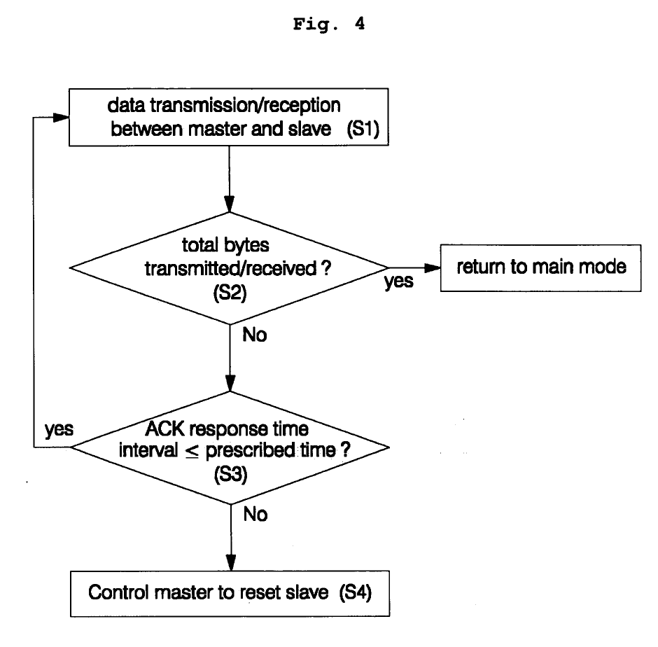

A slave reset method for use in the multi-microprocessor apparatus will hereinafter be described with reference to FIG. 4.

Referring to FIG. 4, in the case where there is data to be transmitted or received between the master and slave microprocessors, the master and slave microprocessors begin data transmission/reception operations at step S1. If the data transmission/receptions have been completed, the slave microprocessor generates an ACK interrupt signal, and outputs the ACK interrupt signal to the master microprocessor. The master microprocessor counts a response time interval of a response signal generated from the slave microprocessor.

The master microprocessor determines whether total bytes of current transmission/reception data are completely transmitted at step S2.

If the total bytes of transmission/reception data have been completely transmitted/received at step S2, data transmission/reception between the master and slave microprocessors is terminated, the master and slave microprocessors each return to a main mode such that they take control of their unique control functions.

Otherwise, if the total bytes of transmission/reception data have not been completely transmitted/received at step S2, the master microprocessor determines whether a response time interval of a response signal transferred from the slave microprocessor via the counter is longer than a predetermined time at step S3.

If the counted time is not equal to the predetermined time, the master and slave microprocessors continue to perform data transmission/reception operations therebetween. Otherwise, if it is determined that the counted time is longer than the predetermined time, the master microprocessor transmits a reset signal to the slave microprocessor at step S4 in such a way that the slave microprocessor is reset.

Therefore, the master microprocessor automatically recognizes an error or shutdown of the slave microprocessor, such that it can reset the slave microprocessor according to the recognized result.

In addition, in the case of generating no ACK interrupt signal according to a data transmission/reception pattern based on the I2C communication standard, the master microprocessor can recognize an error or shutdown of the slave microprocessor without analyzing information (e.g., data packet, etc.) received from the slave microprocessor.

Therefore, the master CPU 12 can easily detect a normal or abnormal condition of the slave microprocessor without analyzing individual standards and errors of data transferred from the slave microprocessor, such that it can easily control the slave microprocessor according to the detected condition information.

As apparent from the above description, a multi-microprocessor apparatus according to the present invention is controlled by master and slave microprocessors. The slave microprocessor transmits a response signal when it transmits/receives data to/from the master microprocessor. The master microprocessor resets the slave microprocessor when a time interval between response signals transferred from the slave microprocessor is longer than a predetermined time, such that it can recognize an error or shutdown of the slave microprocessor on the basis of the ACK interrupt signal generated during a signal transmission/reception time based on the I2C protocol communication standard. In conclusion, the master microprocessor automatically resets a corresponding slave microprocessor when it detects the shutdown of the slave microprocessor, resulting in improved system stability and greater convenience for the user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A multi-microprocessor apparatus controlled by a master microprocessor and a slave microprocessor, comprising:
a slave microprocessor that transmits a response signal to a master microprocessor during a data transmission/reception time therebetween; and
a master microprocessor that resets the slave microprocessor if a time interval between response signals transferred from the slave microprocessor is longer than a predetermined time.

2. The apparatus as set forth in claim 1, wherein the master and slave microprocessors are designed to perform data transmission/reception operations therebetween according to an I2C communication standard.

3. The apparatus as set forth in claim 2, wherein the master microprocessor is designed to transmit a reset signal to the slave microprocessor when the slave microprocessor does not transmit an ACK interrupt signal before reaching a transmission/reception time of total bytes of data to be transmitted/received.

4. The apparatus as set forth in claim 3, wherein the slave microprocessor is reset upon receiving the reset signal from the master microprocessor.

5. The apparatus as set forth in claim 2, wherein the master microprocessor includes:
an I/O port that transmits/receives data to/from the slave microprocessor according to the I2C communication standard;
a master CPU that transmits a control signal to the slave microprocessor via the I/O port, and at the same time receives data from the slave microprocessor;
a counter that counts a time interval of a response signal transferred from the slave microprocessor during a data transmission/reception time between the master and slave microprocessors; and
a reset signal generator that generates a reset signal according to a control signal of the master CPU when a counted time of the counter is longer than a predetermined time, and outputs the reset signal to the slave microprocessor.

6. The apparatus as set forth in claim 5, wherein the master microprocessor controls the reset signal generator to reset the slave microprocessor when the time interval of the response signal is longer than a predetermined time of 10 ms during a data transmission/reception time of the master microprocessor.

7. The apparatus as set forth in claim 2, wherein the slave microprocessor includes:
an I/O port that transmits/receives data to/from the master microprocessor according to the I2C communication standard;
a slave CPU that receives a control signal from the master microprocessor via the I/O port, and controls the slave microprocessor according to the control signal of the master microprocessor; and
a reset unit that receives a reset signal from the master microprocessor, and resets the slave CPU according to the received reset signal.

8. A method for resetting a slave microprocessor in a multi-microprocessor apparatus controlled by a master microprocessor and the slave microprocessor, comprising:
a) controlling the master microprocessor to transmit/receive data to/from the slave microprocessor;
b) controlling the master microprocessor to count a transmission time interval between response signals transferred from the slave microprocessor while the master microprocessor performs the data transmission/reception at (a); and
c) controlling the master microprocessor to reset the slave microprocessor when the counted time interval of (b) is longer than a predetermined time.

9. The method as set forth in claim 8, wherein the data transmission/reception of (a) is established according to an I2C communication standard.

10. The method as set forth in claim 9, wherein (a) includes:
a1) controlling the slave microprocessor to generate an ACK interrupt signal during a data communication time between the master and slave microprocessors, and transmitting the generated ACK interrupt signal to the master microprocessor.

11. The method as set forth in claim 9, wherein (b) includes:
b1) controlling the master microprocessor to determine whether total bytes of current data communicating with the slave microprocessor are completely transmitted/received.

12. The method as set forth in claim 11, wherein (b) includes:
b2) if the total bytes of current data are not completely transmitted/received, controlling the master microprocessor to determine whether the time interval of the response signal transferred from the slave microprocessor is longer than a predetermined time of 10 ms.

13. The method as set forth in claim 9, wherein (c) includes:
c1) if the time interval of the response signal is longer than the predetermined time, controlling the master microprocessor to generate a reset signal, transmitting the reset signal to the slave microprocessor, and resetting the slave microprocessor according to the transmission result.
